(19) United States
(12) Patent Application Publication
(10) Pub. No.: US 2006/0092004 A1
(43) Pub. Date: May 4, 2006

(54) Optical sensor

(76) Inventors: Albrecht Klotz, Aichfal (DE); Dick Schmid, Simmozheim (DE); Jens Schick, Herrenberg (DE)

Correspondence Address: KENYON & KENYON LLP, ONE BROADWAY, NEW YORK, NY, 10004, US

(21) Appl. No.: 10/531,214

(22) PCT Filed: Aug. 11, 2003
(86) PCT No.: PCT/DE03/02706

§ 371 Date: Sep. 6, 2005

(30) Foreign Application Priority Data
Oct. 15, 2002 (DE) 10247925.9

(51) Int. Cl. B60Q 1/00

(52) U.S. Cl. 340/435

(57) ABSTRACT

In a sensor, in which light beams are emitted in various directions, reflected at objects that may be present, received again and evaluated according to direction and transit time in the sense of a three-dimensional imaging of the objects, light sources are arranged in the form of a two-dimensional matrix for generating the light beams.

### FIELD OF THE INVENTION

The present invention relates to a sensor, in which light beams are emitted in various directions, reflected at objects that may be present, received again and evaluated according to direction and transit time in the sense of a three-dimensional imaging of the objects.

### BACKGROUND INFORMATION

Sensors known as lidar sensors (i.e., light detection and ranging) are available on the market. Distinction is made between two different types of construction, namely, sensors having a fixed measuring-beam arrangement in a horizontal plane, for example, and those having mechanical beam swinging, e.g., through mirrors. Although the mechanics allow a finer angular resolution than is possible in the case of a fixed, rectilinear measuring-beam arrangement, they have the known disadvantages of a mechanical design approach, namely, sensitivity to mechanical stress, wear and tear, and relatively costly production.

The known lidar sensors may be used for assistance systems for motor vehicles on the basis of surround field sensors, for object detection, and for measuring distances and relative velocities. The ACC function (i.e., adaptive cruise control, also known under brand trademarks such as Abstandsregeltempomat (proximity-controlled cruise control) and Distronic) is presently in the fore, a measuring range of approximately 3 m to 120 m with a narrow aperture (beam) angle being necessary. In the automotive sector, a number of functions can be realized in the close range up to 30 m distance such as “low speed following”, “blind spot detection”, “backing aid” or “precrash” using lidar sensors, if a wide sensing range exists both horizontally and vertically, with sufficiently high angular resolution in both directions.

An object of the present invention is to provide a sensor for this purpose, which, in particular, satisfies the demands in the automotive industry with respect to manufacturability, reliability, robustness and service life.

### SUMMARY OF THE INVENTION

This objective is achieved in the sensor of the present invention by arranging light sources in the form of a two-dimensional matrix for generating the light beams.

Because of the lack of mechanically moving parts, the sensor of the present invention has a longer service life, even under rough environmental conditions, e.g., vibration. In addition, due to the planar layout of the light sources and, optionally, optical devices on a printed circuit board, manufacturing expenditure is low.

In certain applications, it may be advantageous if the light sources are at different distances from one another.

With regard to easy producibility of the sensor according to the present invention with the aid of available component parts, according to one further development, it can be provided to arrange the light sources on rectilinear subassemblies. However, manufacturing methods are certainly known which permit the mounting of the light sources as individual components on a printed circuit board, e.g., using chip-on-board technology.

In another embodiment of the invention, the individual light sources are staggered in zigzag fashion, in each case within one column.

In addition to the advantages cited, one refinement of the sensor according to the present invention has the advantage of great flexibility, because the light sources are controllable independently of one another.

Thus, for example, the sensing range may be adapted very quickly during operation to the driving situation or the object scene, so that, for instance, quickly moving objects may be selectively tracked. This capability is especially important for safety-related functions such as precrash.

Suitable processors to be programmed and other electronic circuits are available for the electronic control of the individual light sources. Thus, for example, the type of control of the light sources can be changed very rapidly in continuous operation; for instance, it is possible to switch over into several measuring modes having different angular sensing ranges and measuring cycle times, depending on the requirement. A complete sweep of the entire range may be accomplished through line-by-line scanning of the measuring beams, given relatively long cycle times. Alternatively, a line scanning or column scanning at a specific height and width is possible. Finally, individual measuring beams may be generated for precise and rapid tracking of individual objects. In this manner, the simultaneous control of various functions such as low-speed following and precrash may be accomplished by coordinated switchover between the various measuring modes of a single sensor.

For the mode switchover or attention control, the sensor of the present invention may be controlled, inter alia, as follows:
Cyclically repeated, horizontal line scan on the middle plane −30° to +30° from the horizontal.
The higher and lower planes are also scanned at greater time intervals, in order to determine the vertical object positions, as well as the position of the vehicle relative to the road surface.
Switchover to a lower or higher plane for the next line-scan cycles according to need (influence of pitch angle or road curvature).

In the sensor of the present invention, the light sources may be formed by light-emitting diodes or laser diodes.

According to one advantageous embodiment, a collective lens may be disposed in front of each light source. In principle, it is possible to design this collective lens for forming the light beams. Often, however, one will prefer to use the collective lens to concentrate as much light emitted by the respective light source as possible onto a common collective lens, which may also be implemented as a combination of several lenses.

Going into details, the cross-sectional form of the light beam may be important, depending on the application. To that end, in one further refinement of the invention, optical waveguides may be provided for shaping the light beams of the individual light sources.

For example, if different angular resolutions are needed in two directions perpendicular to each other, it may be advantageous if the light beams emitted by the individual light sources have elliptical cross-sections.

The present invention also includes that an optical receiver having a collective lens and a light-sensitive area is provided for receiving the beams reflected by the objects. In this context, the light-sensitive area may be formed by an optoelectric receiver, e.g., by a suitably large-area PIN diode.

Another possibility for advantageously implementing a receiver is for the light-sensitive area to be formed by optoelectric receivers arranged in a matrix configuration. The advantage of this arrangement lies, first of all, in the higher switching speed of the small diodes, resulting in greater measuring accuracy and a radial separation capability, and secondly, in the greater angle selectivity, which becomes noticeable in the avoidance of cross feed between the measuring beams. Intermediate design approaches, such as an array of column-shaped PIN diodes, may also be used for the two specific embodiments of the light-sensitive area.

### BRIEF DESCRIPTION OF THE DRAWINGS

FIG. 1 shows a schematic representation of the arrangement of light sources in a matrix.

FIG. 2 shows a schematic representation of a motor vehicle provided with two sensors according to the present invention.

FIG. 3 shows a schematic representation of a cross-section through a sensor having a transmitter and a receiver, respectively.

FIG. 4 shows another specific embodiment of a receiver.

### DETAILED DESCRIPTION

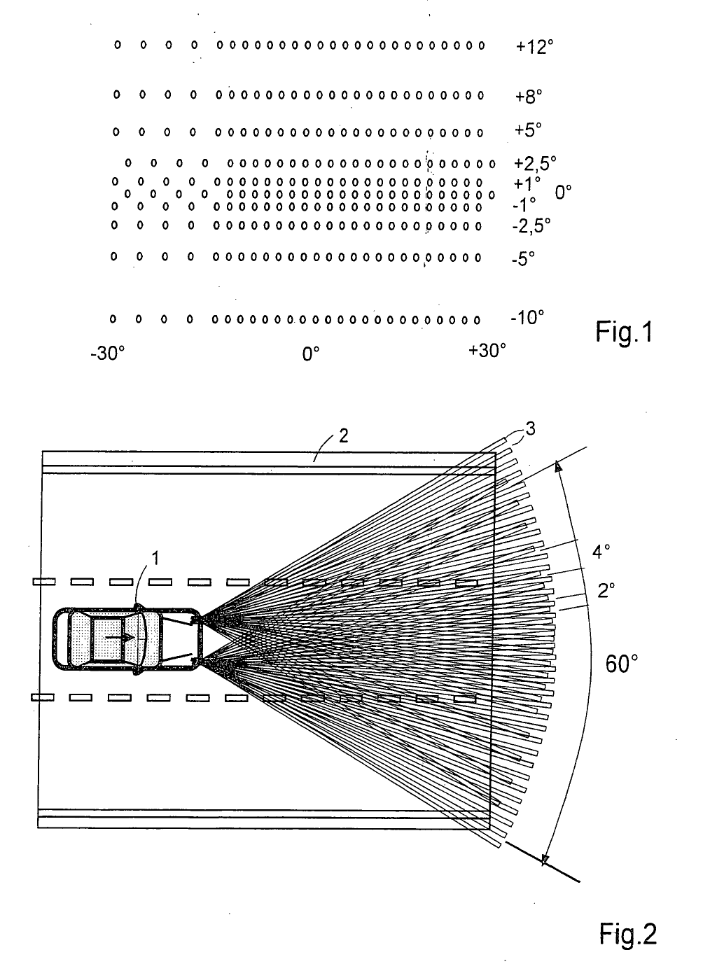

FIG. 1 shows ten rows (lines) of light sources 1, each having an elliptical cross-section. The vertical angular coverage achievable with a predetermined lens extends between −10° and +12° in this example. As the vertical angular coverage becomes greater, the distance of the rows from one another becomes greater, starting from 0°. This takes into account the circumstance that, in general, a more precise angular resolution is necessary in the horizontal plane at the level of the sensor installation position.

Moreover, in the example, the distances between the light sources are chosen to be greater in a left part of the matrix, so that the angular resolution is less here. At the same time, the light sources with low vertical angular coverage are staggered in this area, so that, for example, vertical edges of objects can be detected with relatively good resolution, in spite of the greater distance.

FIG. 2 shows a motor vehicle 1 on a road 2, with an indicated coverage (sensing) space formed by two sensors (not shown in detail), which emit light beams 3 and receive reflections from objects. As shown in FIG. 1, in the case of the sensor located on the right side of the vehicle, the angular resolution was reduced to 4° at the left side, compared to 2° throughout the remaining horizontal sensing range and vice versa. This measure saves on light-emitting diodes, but also becomes advantageously noticeable in that, all in all, a smaller cycle time is possible, while retaining the resolution in the more important region.

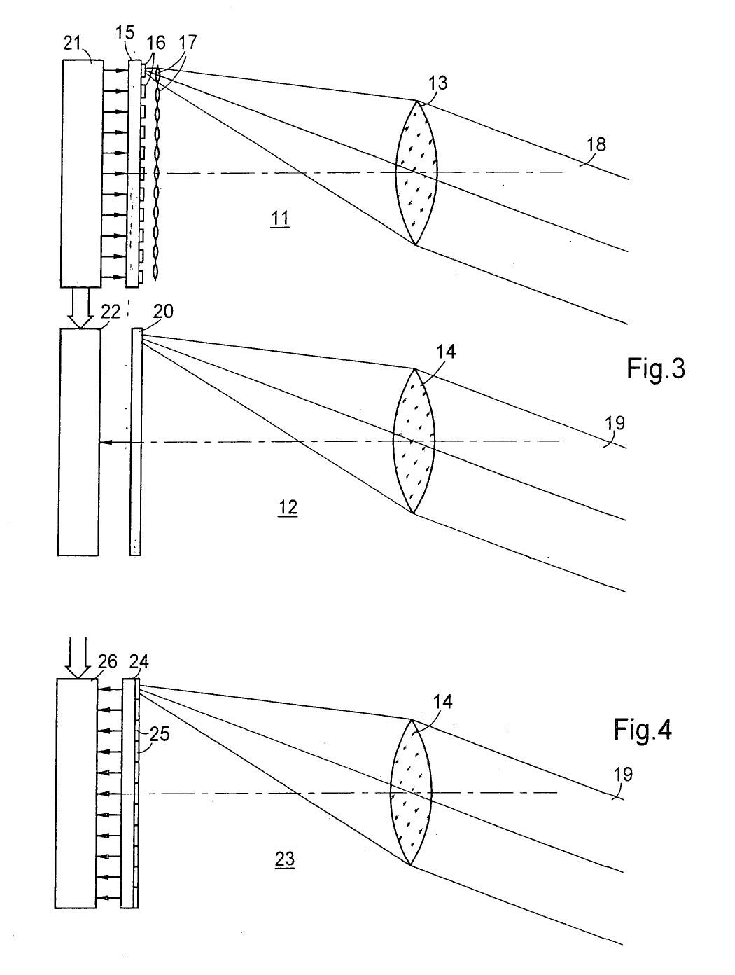

FIG. 3 shows a sensor of the present invention having a transmitter 11 and a receiver 12, each having a lens 13, 14. On a printed circuit board 15 of the transmitter are light-emitting diodes 16, arranged, for example, with the distribution shown in FIG. 1, each provided with a lens 17 that causes the greatest possible portion of the light generated by the light-emitting diode to fall on lens 13, and therefore be used for the light beam. Light-emitting diodes 16 are disposed in the focal plane of lens 13, so that the light generated in each instance by a light-emitting diode 16 produces a bundle of parallel rays 18. Bundle of rays 19, reflected by an object (not shown), is concentrated in receiver 12 of the exemplary embodiment according to FIG. 3, onto a point of large-area PIN diode 20.

A suitable electronic control circuit 21 is used for the pulsed, sequential driving of light-emitting diodes 16, various modes being possible depending on the application case. The information as to which light-emitting diodes 16 emit light at what time is transferred to an evaluation circuit 22 of the receiver, so that the pulses generated by PIN diode 20 may be assigned to the light pulses emitted by light-emitting diodes 16, the transit time then being ascertained. Consequently, in turn, together with the direction information of the light beams, a three-dimensional image of the detected scene may be created.

FIG. 4 shows an alternative 23 for receiver 12 (FIG. 3) having a printed circuit board 24, on which a number of PIN diodes 25 corresponding to the transmitter are arranged, which, as described at the outset, permits, inter alia, an increase in security against cross feed between the individual light beams. Evaluation circuit 26 of receiver 23 has a corresponding number of inputs.

1-15. (canceled)

16. A sensor comprising:
light sources situated in the form of a two-dimensional matrix for generating light beams emitted in various directions;
means for receiving light beams reflected by objects; and
means for evaluating the received light beams according to direction and transmit time in the sense of a three-dimensional imaging of the objects.

17. The sensor according to claim 16, wherein the light sources are at different distances from each other.

18. The sensor according to claim 16, wherein the light sources are situated on column-shaped subassemblies.

19. The sensor according to claim 16, wherein the light sources are mounted as individual components on a printed circuit board.

20. The sensor according to claim 16, wherein the individual light sources are staggered in zigzag fashion, in each case within one column.

21. The sensor according to claim 16, wherein the light sources are controllable independently of one another.

22. The sensor according to claim 16, wherein the light sources include light-emitting diodes.

23. The sensor according to claim 16, wherein the light sources include laser diodes.

24. The sensor according to claim 16, further comprising a collective lens situated in front of each light source.

25. The sensor according to claim 16, further comprising a common collective lens.

26. The sensor according to claim 16, further comprising optical waveguides for shaping the light beams of the individual light sources.

27. The sensor according to claim 16, wherein the light beams emitted by the individual light sources have elliptical cross-sections.

28. The sensor according to claim 16, wherein the means for receiving includes an optical receiver having a collective lens and a light-sensitive area for receiving the beams reflected by the objects.

29. The sensor according to claim 28, wherein the light-sensitive area includes an optoelectric receiver.

30. The sensor according to claim 28, wherein the light-sensitive area includes optoelectric receivers situated in a matrix configuration.
